(19) United States
(12) Patent Application Publication
(10) Pub. No.: US 2026/0006536 A1
(43) Pub. Date: Jan. 1, 2026

(54) COMMUNICATION METHOD AND APPARATUS, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/881,093

(22) PCT Filed: Jul. 5, 2022
(86) PCT No.: PCT/CN2022/103956

§ 371 Date: Jan. 3, 2025

(51) Int. Cl. H04W 48/16; H04W 48/08

(52) U.S. Cl. CPC H04W 48/16; H04W 48/08

(57) ABSTRACT

A communication method is applied to a non-access-point multi-link device (Non-AP MLD) and includes: determining a target radio frame, where the target radio frame includes a first identification bit, and the first identification bit indicates that a target traffic identifier (TID) is mapped to a new link corresponding to a new affiliated AP of an access point multi-link device (AP MLD); and sending the target radio frame.

### CROSS-REFERENCE TO RELATED APPLICATIONS

This application is a U.S. National Stage of International Application No. PCT/CN2022/103956, filed on Jul. 5, 2022, the content of which is incorporated by reference herein in its entirety for all purposes.

### TECHNICAL FIELD

Embodiments of this disclosure relate to the field of mobile communication technology. Specifically, embodiments of this disclosure relate to a communication method and apparatus, an electronic device, and a storage medium.

### BACKGROUND

With the rapid development of mobile communication technology, Wi-Fi (Wireless Fidelity) technology has made great progress in terms of transmission rate and throughput. Currently, Wi-Fi technology is researched on content such as 320 Mhz bandwidth transmission, aggregation and collaboration of multiple frequency bands, and the like, where main application scenarios thereof include video transmission, AR (Augmented Reality), VR (Virtual Reality) and the like

Specifically, the aggregation and collaboration of multiple frequency bands refers to the simultaneous communication between devices in 2.4 GHz, 5.8 GHz, 6 GHz and other frequency bands. For scenarios in which devices communicate in multiple frequency bands simultaneously, new MAC (Media Access Control) mechanism is to be defined for management. In addition, the aggregation and coordination of multiple frequency bands is expected to support low-latency transmission.

Currently, the maximum bandwidth supported by multi-band aggregation and collaboration technology is 320 MHz (160 MHz+160 MHz). In addition, it may also support 240 MHz (160 MHz+80 MHz) and other bandwidths supported by existing standards.

In the multi-link scenario of the Wi-Fi technology currently being studied, the AP MLD (Access Point Multi-Link Device) may delete/add its affiliated AP. When the affiliated AP changes, it may cause implementation failure of TID-to-Link (Traffic Identifier-to-Link) mapping mechanism. Therefore, it is necessary to provide a way to implement the TID-to-Link mapping mechanism in the multi-link scenario.

### SUMMARY

Embodiments of this disclosure provide a communication method and apparatus, an electronic device, and a storage medium, thereby proposing a way to implement the TID-to-Link mapping mechanism in the multi-link scenario.

According to an aspect, embodiments of this disclosure provide a communication method, which is applied to a non-access-point multi-link device (Non-AP MLD) and includes:
determining a target radio frame, wherein the target radio frame includes a first identification bit, and the first identification bit indicates that a target traffic identifier (TID) is mapped to a new link corresponding to a new affiliated AP of an access point multi-link device (AP MLD); and
sending the target radio frame.

According to another aspect, embodiments of this disclosure provide a communication method, which is applied to an AP MLD and includes:
receiving a target radio frame, wherein the target radio frame includes a first identification bit, and the first identification bit indicates that a TID is mapped to a new link corresponding to a new affiliated AP of the AP MLD; and
mapping, according to the first identification bit, the target TID to the new link corresponding to the new affiliated AP.

According to another aspect, embodiments of this disclosure provide an electronic device, which is a Non-AP MLD and includes:
a determining module, configured to determine a target radio frame, wherein the target radio frame includes a first identification bit, and the first identification bit indicates that a target TID is mapped to a new link corresponding to a new affiliated AP of an AP MLD; and
a sending module, configured to send the target radio frame.

According to another aspect, embodiments of this disclosure provide an electronic device, which is an AP MLD and includes:
a receiving module, configured to receive a target radio frame, wherein the target radio frame includes a first identification bit, and the first identification bit indicates that a target TID is mapped to a new link corresponding to a new affiliated AP of the AP MLD; and
a mapping module, configured to map, according to the first identification bit, the target TID to the new link corresponding to the new affiliated AP.

Embodiments of this disclosure further provide an electronic device, including a memory, a processor and a computer program stored in the memory and executable on the processor, wherein the processor is configured to, upon executing the program, implement one or more methods according to embodiments of this disclosure.

Embodiments of this disclosure further provide a computer-readable storage medium, storing a computer program thereon, wherein the computer program is used for, upon being executed by a processor, implementing one or more methods according to embodiments of this disclosure.

In some embodiments of this disclosure, the Non-AP MLD determines a target radio frame, where the target radio frame includes a first identification bit, and the first identification bit indicates mapping a target TID to a new link corresponding to a new affiliated AP of an AP MLD; and sends the target radio frame. Accordingly, after receiving the target radio frame, the AP MLD creates the TID-to-Link mapping for the link of the new affiliated AP based on the first identification bit, thereby implementing communication between the Non-AP MLD and the new affiliated AP, so as to improve regional throughput and implement the TID-to-Link mapping mechanism in multi-link scenarios.

Additional aspects and advantages of the disclosed embodiments will be set forth in part in the description which follows, and will be apparent from the description, or may be learned by practice of the present disclosure.

### BRIEF DESCRIPTION OF THE DRAWINGS

In order to more clearly illustrate the technical solutions according to some embodiments of this disclosure, the drawings needed to be used in the description of the embodiments of this disclosure will be briefly introduced below. The drawings in the following description are only some embodiments of this disclosure. For those of ordinary skill in the art, other drawings can also be obtained based on these drawings without exerting creative labor.

FIG. 1 is a first flowchart of a communication method according to some embodiments of this disclosure.

FIG. 2 is a second flowchart of a communication method according to some embodiments of this disclosure.

FIG. 3 is a third flowchart of a communication method according to some embodiments of this disclosure.

FIG. 4 is a fourth flowchart of a communication method according to some embodiments of this disclosure.

FIG. 5 is a fifth flowchart of a communication method according to some embodiments of this disclosure.

FIG. 6 is a first schematic structural diagram of an electronic device according to some embodiments of this disclosure.

FIG. 7 is a second schematic structural diagram of an electronic device according to some embodiments of this disclosure.

FIG. 8 is a third schematic structural diagram of an electronic device according to some embodiments of this disclosure.

### DETAILED DESCRIPTION

In the embodiments of this disclosure, the term “and/or” describes the association relationship of associated objects, indicating that there may be three relationships. For example, when referring to A and/or B, it may mean three situations: A exists alone, both A and B exist, or B exists alone. The character “/” generally indicates that the related objects are in an “or” relationship.

In the embodiments of this disclosure, the term “plurality/multiple” refers to two or more than two, and so does other quantifiers.

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with this application. Rather, they are merely examples of apparatus and methods consistent with aspects of the application as detailed in the appended claims.

The terminology used in this disclosure is for the purpose of describing particular embodiments only and is not intended to limit the disclosure. As used in this disclosure and the appended claims, the singular forms “a/an,” “the” and “said” are intended to include the plural forms as well, unless the context clearly dictates otherwise. It will also be understood that the term “and/or” as used herein refers to and includes any and all possible combinations of one or more of the associated listed items.

It should be understood that although the terms first, second, third, etc. may be used in this disclosure to describe various information, the information should not be limited to these terms. These terms are only used to distinguish information of the same type from each other. For example, without departing from the scope of this disclosure, the first information may also be called second information, and similarly, the second information may also be called first information. Depending on the context, the word “if” as used herein may be interpreted as “when” or “while” or “in response to determining.”

The technical solutions according to some embodiments of this disclosure will be clearly and completely described below with reference to the accompanying drawings in the embodiments of this disclosure. The described embodiments are only some of the embodiments of this disclosure, not all of them. Based on the embodiments in this disclosure, all other embodiments obtained by those of ordinary skill in the art without creative efforts fall within the protection scope of this disclosure.

Embodiments of this disclosure provide a communication method and apparatus, an electronic device, and a storage medium, thereby proposing a way to implement the TID-to-Link mapping mechanism in the multi-link scenarios.

In the embodiments, the method and the device are based on the same application concept. Since the principles of the method and the device to solve the problem are similar, the implementation of the device and the method can be referred to each other, and the repeated details will not be repeated.

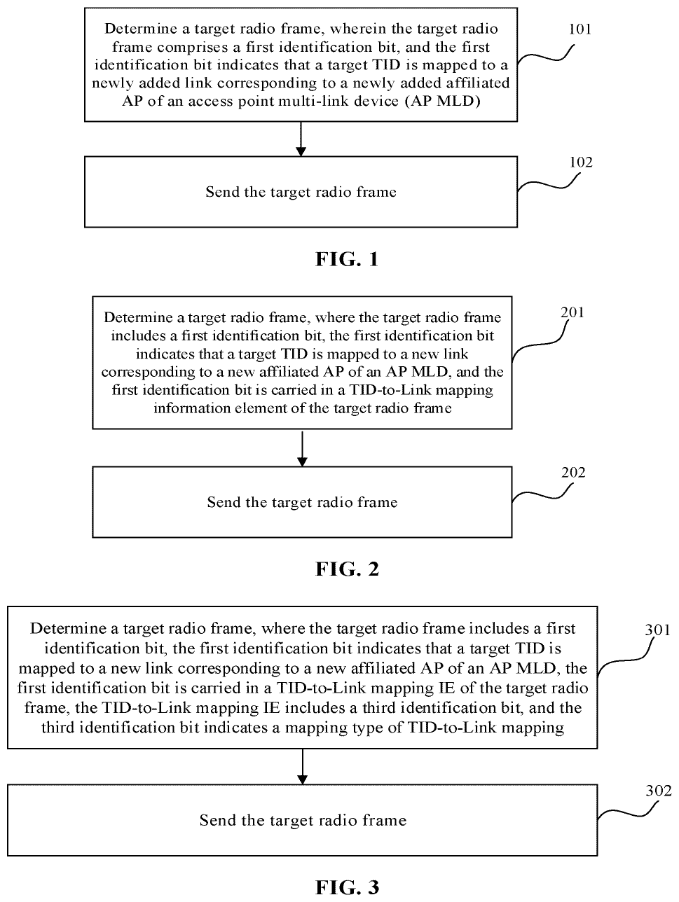

As shown in FIG. 1, some embodiments of this disclosure provide a communication method. Optionally, the method may be applied to an electronic device. The electronic device may be a non-access-point multi-link device (Non-AP MLD). The method may include the following steps.

In step 101, a target radio frame is determined, where the target radio frame includes a first identification bit, and the first identification bit indicates that a target traffic identifier (TID) is mapped to a new link corresponding to a new affiliated AP of an access point multi-link device (AP MLD).

Generally speaking, an AP MLD can add a new affiliated AP (hereinafter referred to as the new affiliated AP) at any time. For example, the AP MLD indicates, through the Basic Multi-Link element in a beacon frame (Beacon) and the Reduced Neighbor Report element, that it adds the new affiliated AP.

Accordingly, when a Non-AP MLD detects that the beacon frame sent by the AP MLD includes the new affiliated AP, it can request the AP MLD to update the TID-to-Link (Traffic Identifier-to-Link) mapping, so as to implement TID mapping for the new affiliated AP. The Non-AP MLD determines the target radio frame, and carries a first identification bit in the target radio frame, where the first identification bit indicates that a target TID is mapped to the new link corresponding to the new affiliated AP of the AP MLD.

Specifically, in the TID-to-Link mapping mechanism, before the AP MLD adds the new affiliated AP, the TID-to-Link mapping has been completed. Since the AP MLD adds the new affiliated AP, which means that the new link is identified, the TID is to be mapped to the new link.

Herein, the target TID may include all TIDs of the AP MLD.

Optionally, the target radio frame may be an association request frame (Association Request), a reassociation request frame (Reassociation Request), or a TID-to-Link mapping request frame (TID-to-Link mapping Request).

In step 102, the target radio frame is sent.

The Non-AP MLD sends the target radio frame. After receiving the target radio frame, the AP MLD creates TID-to-Link mapping for the link of the new affiliated AP according to the first identification bit, thereby implementing communication between the Non-AP MLD and the new affiliated AP, so as to improve regional throughput and implement the TID-to-Link mapping mechanism in multi-link scenarios.

Referring to FIG. 2, some embodiments of this disclosure further provide a communication method. Optionally, the method may be applied to a Non-AP MLD. The method may include the following steps.

In step 201, a target radio frame is determined, where the target radio frame includes a first identification bit, the first identification bit indicates that a target TID is mapped to a new link corresponding to a new affiliated AP of an AP MLD, and the first identification bit is carried in a TID-to-Link mapping information element (IE) of the target radio frame.

Herein, the target radio frame includes a TID-to-Link mapping IE, and carries a first identification bit in the TID-to-Link mapping IE, so as to indicate, through the first identification bit, the AP MLD to map the target TID to the new link corresponding to the new affiliated AP of the AP MLD. As a first example, the TID-to-Link mapping IE is shown in Table 1 below.

TABLE 1

| | | | Element | TID-To-Link | Link Mapping | | Link Mapping |
|---|---|---|---|---|---|---|---|
| | Element | | ID | Mapping | Of TID 0 | . . . | Of TID 7 |
| Content | ID | Length | Extension | Control | (Optional) | . . . | (Optional) |
| Octets | 1 | 1 | 1 | 2 | 0 or 2 | . . . | 0 or 2 |
| | | | | | | . . . | |

During the multi-link (re) establishment process, if the AP MLD has indicated to perform TID-to-Link mapping negotiation, the non-AP MLD can initiate the TID-to-Link mapping negotiation in the (re) association request frame.

Optionally, the first identification bit can be carried in a TID-To-Link Mapping control field of the TID-to-Link mapping IE. The format of the TID-To-Link Mapping control field may be as shown in Table 2. It can be in the TID-To-Default Link Mapping of the Link Mapping control field is used as the first identification bit.

TABLE 2

| | | | |
|---|---|---|---|
| Direction | Default Link Mapping | Reserved | Link Mapping Presence Indicator |

In step 202, the target radio frame is sent.

The Non-AP MLD sends the target radio frame. After receiving the target radio frame, the AP MLD creates TID-to-Link mapping for the link of the new affiliated AP according to the first identification bit in the TID-to-Link mapping IE, thereby implementing communication between the Non-AP MLD and the new affiliated AP, so as to improve regional throughput and implement the TID-to-Link mapping mechanism in multi-link scenarios.

In an optional embodiment, the control field of the TID-to-Link mapping IE includes a second identification bit, where the second identification bit indicates that the TID-to-Link mapping IE is TID-to-Link mapping of the new link. Referring to Table 2 above, the second identification bit may be added in the subfield “Reserved” of the TID-To-Link Mapping control field to identify the TID-to-Link mapping IE as mapping of the new link.

Referring to FIG. 3, some embodiments of this disclosure further provide a communication method. Optionally, the method may be applied to a Non-AP MLD. The method may include the following steps.

In step 301, a target radio frame is determined, where the target radio frame includes a first identification bit, the first identification bit indicates that a target TID is mapped to a new link corresponding to a new affiliated AP of an AP MLD, the first identification bit is carried in a TID-to-Link mapping IE of the target radio frame, the TID-to-Link mapping IE includes a third identification bit, and the third identification bit indicates a mapping type of TID-to-Link mapping.

The mapping types include: uplink mapping, downlink mapping, and uplink&downlink mapping. In some embodiments, the mapping type is the mapping direction, as shown in the subfield “Direction” in Table 2. Optionally, the subfield “Direction” can be set to three values: “0” means uplink mapping, “1” means downlink mapping, “2” means uplink&downlink mapping.

In step 302, the target radio frame is sent.

The Non-AP MLD sends the target radio frame. After receiving the target radio frame, the AP MLD determines the mapping type based on the third identification bit of the TID-to-Link mapping IE and creates TID-to-Link mapping for the link of the new affiliated AP, thereby implementing communication between the Non-AP MLD and the new affiliated AP, so as to improve regional throughput and implement the TID-to-Link mapping mechanism in multi-link scenarios.

In an optional embodiment, when the mapping type includes uplink mapping or downlink mapping, the target radio frame includes two TID-to-Link mapping IEs, which are uplink mapping and downlink mapping respectively.

The control field of the TID-to-Link mapping IE may include a fourth identification bit, where the fourth identification bit indicates that the TID-to-Link mapping IE is the TID-to-Link mapping of the new link. The fourth identification bit is added in the control field to identify the TID-to-Link mapping IE as the mapping of the new link.

In an optional embodiment, the fourth identification bit is carried in a reserved subfield of the control filed, as shown by the subfield “Reserved” in Table 2.

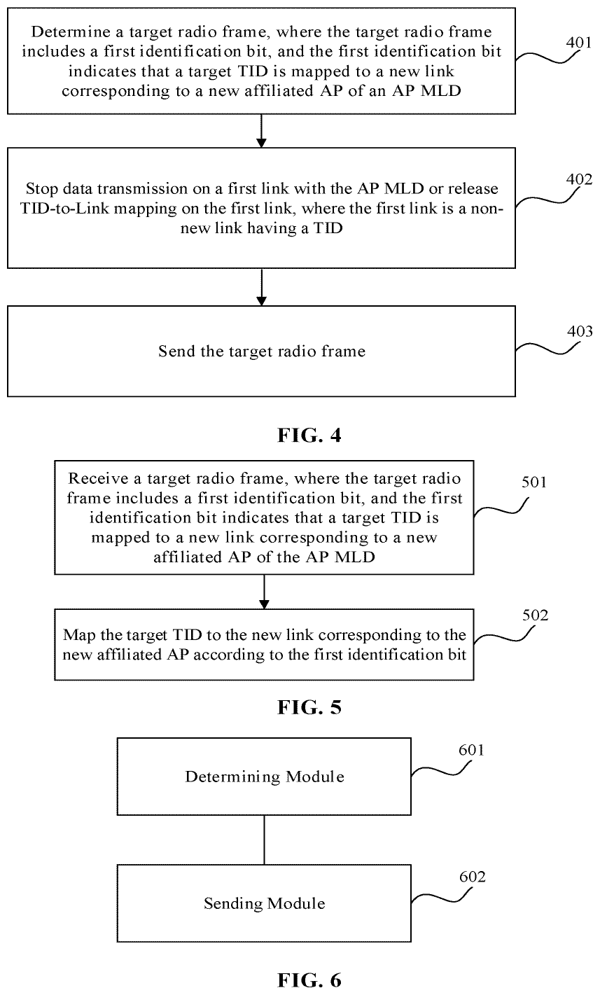

Referring to FIG. 4, some embodiments of this disclosure further provide a communication method. Optionally, the method may be applied to a Non-AP MLD. The method may include the following steps.

In step 401, a target radio frame is determined, where the target radio frame includes a first identification bit, and the first identification bit indicates that a target TID is mapped to a new link corresponding to a new affiliated AP of an AP MLD.

Generally speaking, an AP MLD can add a new affiliated AP (hereinafter referred to as the new affiliated AP) at any time. For example, the AP MLD indicates, through the Basic Multi-Link element in a beacon frame (Beacon) and the Reduced Neighbor Report element, that it adds the new affiliated AP.

Accordingly, when a Non-AP MLD detects that the beacon frame sent by the AP MLD includes the new affiliated AP, it can request the AP MLD to update the TID-to-Link mapping, so as to implement TID mapping for the new affiliated AP. The Non-AP MLD determines the target radio frame, and carries a first identification bit in the target radio frame, where the first identification bit indicates that a target TID is mapped to the new link corresponding to the new affiliated AP of the AP MLD.

Specifically, in the TID-to-Link mapping mechanism, before the AP MLD adds the new affiliated AP, the TID-to-Link mapping has been completed. Since the AP MLD adds the new affiliated AP, which means that the new link is identified, the TID is to be mapped to the new link.

Herein, the target TID may include all TIDs of the AP MLD.

Optionally, the target radio frame may be an association request frame (Association Request), a reassociation request frame (Reassociation Request), or a TID-to-Link mapping request frame (TID-to-Link mapping Request).

In step 402, data transmission is stopped on a first link with the AP MLD or TID-to-Link mapping on the first link is released, where the first link is a non-new link having a TID.

After the AP MLD adds the new affiliated AP, during the TID-to-Link mapping renegotiation process between the Non-AP MLD and the AP MLD, it is to ensure that, before the negotiation is completed, data transmission is not performed on the non-new link already having TID mapping (there may be a situation where the original TID mapping has changed, so some links may no longer have TID), so as to avoid communication interruptions caused by the negotiation process. Here, the non-new link is the original link between the Non-AP MLD and the AP MLD.

In addition, the TID-to-Link mapping on the first link may also be released, that is, the TID-to-Link mapping mechanism on the first link that was negotiated may be deleted through the TID-to-Link teardown mechanism.

In step 403, the target radio frame is sent.

In some embodiments of this disclosure, the Non-AP MLD determines the target radio frame, where the target radio frame includes the first identification bit, and the first identification bit indicates mapping the target TID to the new link corresponding to the new affiliated AP of the AP MLD; and sends the target radio frame. Accordingly, after receiving the target radio frame, the AP MLD creates the TID-to-Link mapping for the link of the new affiliated AP based on the first identification bit, thereby implementing communication between the Non-AP MLD and the new affiliated AP, so as to improve regional throughput and implement the TID-to-Link mapping mechanism in multi-link scenarios.

Referring to FIG. 5, some embodiments of this disclosure further provide a communication method. Optionally, the method may be applied to an AP MLD. The method may include the following steps.

In step 501, a target radio frame is received, where the target radio frame includes a first identification bit, and the first identification bit indicates that a target TID is mapped to a new link corresponding to a new affiliated AP of the AP MLD.

Generally speaking, an AP MLD can add a new affiliated AP (hereinafter referred to as the new affiliated AP) at any time. For example, the AP MLD indicates, through the Basic Multi-Link element in a beacon frame (Beacon) and the Reduced Neighbor Report element, that it adds the new affiliated AP.

Accordingly, when a Non-AP MLD detects that the beacon frame sent by the AP MLD includes the new affiliated AP, it can request the AP MLD to update the TID-to-Link mapping, so as to implement TID mapping for the new affiliated AP. The AP MLD receives the target radio frame sent by the Non-AP MLD, and obtains the first identification bit carried in the target radio frame, where the first identification bit indicates that a target TID is mapped to the new link corresponding to the new affiliated AP of the AP MLD.

Specifically, in the TID-to-Link mapping mechanism, before the AP MLD adds the new affiliated AP, the TID-to-Link mapping has been completed. Since the AP MLD adds the new affiliated AP, which means that the new link is identified, the TID is to be mapped to the new link.

Herein, the target TID may include all TIDs of the AP MLD.

Optionally, the target radio frame may be an association request frame (Association Request), a reassociation request frame (Reassociation Request), or a TID-to-Link mapping request frame (TID-to-Link mapping Request).

In step 502, the target TID is mapped to the new link corresponding to the new affiliated AP according to the first identification bit.

The AP MLD maps the target TID to the new link corresponding to the new affiliated AP according to the first identification bit, and creates TID-to-Link mapping for the link of the new affiliated AP, thereby implementing communication between the Non-AP MLD and the new affiliated AP, so as to improve regional throughput and implement the TID-to-Link mapping mechanism in multi-link scenarios.

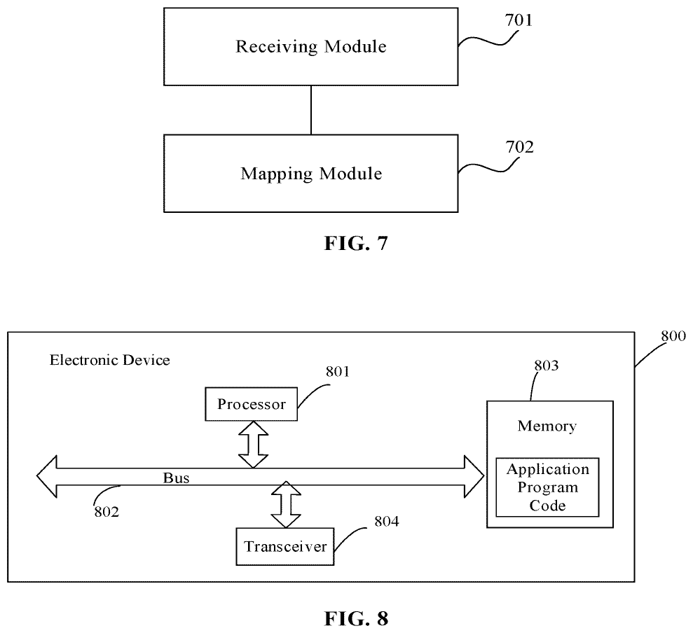

Referring to FIG. 6, based on the same principle as the communication method according to some embodiments of this disclosure, some embodiments of this disclosure further provide an electronic device. The electronic device is a Non-AP MLD. The electronic device includes a determining module 601 and a sending module 602.

The determining module 601 is configured to determine a target radio frame, where the target radio frame includes a first identification bit, and the first identification bit indicates that a target TID is mapped to a new link corresponding to a new affiliated AP of an AP MLD.

Generally speaking, an AP MLD can add a new affiliated AP (hereinafter referred to as the new affiliated AP) at any time. For example, the AP MLD indicates, through the Basic Multi-Link element in a beacon frame (Beacon) and the Reduced Neighbor Report element, that it adds the new affiliated AP.

Accordingly, when a Non-AP MLD detects that the beacon frame sent by the AP MLD includes the new affiliated AP, it can request the AP MLD to update the TID-to-Link mapping, so as to implement TID mapping for the new affiliated AP. The Non-AP MLD determines the target radio frame, and carries a first identification bit in the target radio frame, where the first identification bit indicates that a target TID is mapped to the new link corresponding to the new affiliated AP of the AP MLD.

Specifically, in the TID-to-Link mapping mechanism, before the AP MLD adds the new affiliated AP, the TID-to-Link mapping has been completed. Since the AP MLD adds the new affiliated AP, which means that the new link is identified, the TID is to be mapped to the new link.

Herein, the target TID may include all TIDs of the AP MLD.

Optionally, the target radio frame may be an association request frame (Association Request), a reassociation request frame (Reassociation Request), or a TID-to-Link mapping request frame (TID-to-Link mapping Request).

The sending module 602 is configured to send the target radio frame.

The Non-AP MLD sends the target radio frame. After receiving the target radio frame, the AP MLD creates TID-to-Link mapping for the link of the new affiliated AP according to the first identification bit, thereby implementing communication between the Non-AP MLD and the new affiliated AP, so as to improve regional throughput and implement the TID-to-Link mapping mechanism in multi-link scenarios.

Optionally, in some embodiments of this disclosure, the first identification bit is carried in a TID-to-Link mapping IE of the target radio frame.

Optionally, in some embodiments of this disclosure, a control field of the TID-to-Link mapping IE includes a second identification bit, and the second identification bit indicates that the TID-to-Link mapping IE is TID-to-Link mapping of the new link.

Optionally, in some embodiments of this disclosure, the TID-to-Link mapping IE includes a third identification bit, and the third identification bit indicates a mapping type of TID-to-Link mapping.

The mapping type includes: uplink mapping, downlink mapping, uplink&downlink mapping.

Optionally, in some embodiments of this disclosure, when the mapping type includes uplink mapping or downlink mapping, the target radio frame includes two TID-to-Link mapping IEs.

The control field of the TID-to-Link mapping IE includes a fourth identification bit, and the fourth identification bit indicates that the TID-to-Link mapping IE is the TID-to-Link mapping of the new link.

Optionally, in some embodiments of this disclosure, the fourth identification bit is carried in a reserved subfield of the control field.

Optionally, in some embodiments of this disclosure, the electronic device includes:

a processing module, configured to stop data transmission on a first link with the AP MLD or releasing TID-to-Link mapping on the first link before the sending module 602 sends the target radio frame, where first link is a non-new link with a TID.

In some embodiments of this disclosure, the determining module 601 determines the target radio frame, where the target radio frame includes the first identification bit, and the first identification bit indicates that the target TID is mapped to the new link corresponding to the new affiliated AP of the AP MLD; the sending module 602 sends the target radio frame, so that after receiving the target radio frame, the AP MLD creates TID-to-Link mapping for the link of the new affiliated AP according to the first identification bit, thereby implementing communication between the Non-AP MLD and the new affiliated AP, so as to improve regional throughput and implement the TID-to-Link mapping mechanism in multi-link scenarios.

Embodiments of this disclosure further provide a communication apparatus applied to a Non-AP MLD. The apparatus includes:
a radio frame determining module, configured to determine a target radio frame, where the target radio frame includes a first identification bit, and the first identification bit indicates that a target TID is mapped to a new link corresponding to a new affiliated AP of an AP MLD; and
a radio frame sending module, configured to send the target radio frame.

The apparatus further includes other modules of the electronic device in the forgoing embodiments, which will not be repeated here.

Referring to FIG. 7, based on the same principle as the communication method according to some embodiments of this disclosure, some embodiments of this disclosure further provide an electronic device. The electronic device is an AP MLD. The electronic device includes:
a receiving module 701, configured to receive a target radio frame, where the target radio frame includes a first identification bit, and the first identification bit indicates that a target TID is mapped to a new link corresponding to a new affiliated AP of the AP MLD; and
a mapping module 702, configured to map the target TID to the new link corresponding to the new affiliated AP according to the first identification bit.

In some embodiments of this disclosure, the receiving module 701 receives the target radio frame, where the target radio frame includes the first identification bit, and the first identification bit indicates that the target TID is mapped to the new link corresponding to the new affiliated AP of the AP MLD; the mapping module 702 maps the target TID to the new link corresponding to the new affiliated AP according to the first identification bit, and creates the TID-to-Link mapping for the link of the new affiliated AP, thereby implementing communication between the Non-AP MLD and the new affiliated AP, so as to improve regional throughput and implement the TID-to-Link mapping mechanism in multi-link scenarios.

Embodiments of this disclosure further provide a communication apparatus applied to a Non-AP MLD. The apparatus includes:
a radio frame receiving module, configured to receive a target radio frame, where the target radio frame includes a first identification bit, and the first identification bit indicates that a target TID is mapped to a new link corresponding to a new affiliated AP of the AP MLD;
a radio frame mapping module, configured to map the target TID to the new link corresponding to the new affiliated AP according to the first identification bit.

The apparatus further includes other modules of the electronic device in the forgoing embodiments, which will not be repeated here.

In an optional embodiment, some embodiments of this disclosure further provide an electronic device, as shown in FIG. 8. The electronic device 800 shown in FIG. 8 may be a server, including a processor 801 and a memory 803. Herein, the processor 801 and the memory 803 are connected, for example, through a bus 802. Optionally, electronic device 800 may further include a transceiver 804. It should be noted that in practical applications, the number of transceivers 804 is not limited to one, and the structure of the electronic device 800 does not constitute a limitation on the embodiments of this disclosure.

The processor 801 may be a CPU (Central Processing Unit), a general-purpose processor, a DSP (Digital Signal Processor), an ASIC (Application Specific Integrated Circuit), an FPGA (Field Programmable Gate Array), or other programmable logic devices, transistor logic devices, hardware components, or any combination thereof, which can implement or execute various illustrative logical blocks, modules and circuits described in connection with this disclosure. The processor 801 may also be a combination that implements computing functions, such as a combination of one or more microprocessors, a combination of a DSP and a microprocessor, or the like.

The bus 802 may include a path that carries information between the above-mentioned components. The bus 802 may be a PCI (Peripheral Component Interconnect) bus, an EISA (Extended Industry Standard Architecture) bus, or the like. The bus 802 may be divided into an address bus, a data bus, a control bus, and the like. For ease of presentation, only one thick line is shown in FIG. 8, but it does not mean that there is only one bus or one type of bus.

The memory 803 may be ROM (Read Only Memory) or other types of static storage devices that can store static information and instructions, or RAM (Random Access Memory) or other types of dynamic storage devices that can store information and instructions. It may also be EEPROM (Electrically Erasable Programmable Read Only Memory), CD-ROM (Compact Disc Read Only Memory) or other optical disk storage, optical disk storage (including compression optical disc, laser disc, optical disc, digital versatile disc, Blu-ray disc, etc.), magnetic disk storage medium or other magnetic storage device, or any other medium that can be used to carry or store the desired program code in the form of instructions or data structures and can be accessed by a computer, and this disclosure is not limited thereto.

The memory 803 is configured to store application code for executing the disclosed solution, and is controlled by the processor 801 for execution. The processor 801 is configured to execute the application program code stored in the memory 803 to implement the contents shown in the foregoing method embodiments.

Herein, electronic devices include but are not limited to: mobile terminals such as mobile phones, notebook computers, digital broadcast receivers, PDAs (personal digital assistants), PAD (tablet computers), PMP (portable multimedia players), and vehicle-mounted terminals (such as vehicle-mounted navigation terminals), or fixed terminals such as digital TVs, and desktop computers. The electronic device shown in FIG. 8 is only an example and should not impose any limitations on the functions and usage scope of the embodiments of this disclosure.

The server provided by this disclosure can be an independent physical server, or a server cluster or distributed system composed of multiple physical servers. It can also be a cloud server that provides basic cloud computing services such as cloud services, cloud databases, cloud computing, cloud functions, cloud storage, network services, cloud communications, middleware services, domain name services, security services, CDN, big data, and artificial intelligence platforms. The terminal may be smartphone, tablet, laptop, desktop computer, smart speaker, smart watch, or the like, but is not limited thereto. The terminal and the server may be connected directly or indirectly through wired or wireless communication manners, and this disclosure is not limited thereto.

Embodiments of this disclosure provide a computer-readable storage medium. The computer-readable storage medium stores a computer program which, when running on a computer, causes the computer to execute the corresponding content in the foregoing method embodiments.

It should be understood that although various steps in the flowchart of the accompanying drawings are shown in sequence as indicated by arrows, these steps are not necessarily performed in the order indicated by arrows. Unless explicitly stated in this article, the execution of these steps is not strictly limited in order, and they can be executed in other orders. Moreover, at least some of the steps in the flow chart of the accompanying drawings may include multiple sub-steps or multiple stages. These sub-steps or stages are not necessarily executed at the same time, but may be executed at different times, and they do not necessarily need to be performed sequentially, but may be performed in turn or alternately with other steps, or at least part of sub-steps or stages of other steps.

It should be noted that the computer-readable medium mentioned above in this disclosure may be a computer-readable signal medium or a computer-readable storage medium, or any combination of the above two. The computer-readable storage medium may be, for example, but is not limited to, an electrical, magnetic, optical, electromagnetic, infrared, or semiconductor system, apparatus or device, or any combination thereof. More specific examples of computer readable storage medium may include, but are not limited to: an electrical connection having one or more wires, a portable computer disk, a hard drive, RAM, ROM, EPROM or flash memory, fiber optics, portable compact disk read-only memory (CD-ROM), optical storage device, magnetic storage device, or any suitable combination of the above. In this disclosure, a computer-readable storage medium may be any tangible medium that contains or stores a program for use by or in connection with an instruction execution system, apparatus, or device. In this disclosure, a computer-readable signal medium may include a data signal propagated in baseband or as part of a carrier wave, carrying computer-readable program code therein. Such propagated data signals may take a variety of forms, including but not limited to electromagnetic signals, optical signals, or any suitable combination of the above. The computer-readable signal medium may also be any computer-readable medium other than a computer-readable storage medium that can send, propagate, or transmit a program for use by or in connection with an instruction execution system, apparatus, or device. Program code embodied on the computer-readable medium may be transmitted using any suitable medium, including but not limited to: wire, optical cable, RF (radio frequency), or any suitable combination of the above.

The above-mentioned computer-readable medium may be included in the above-mentioned electronic device, or may also exist independently without being assembled into the electronic device.

The computer-readable medium carries one or more programs. When the one or more programs are executed by the electronic device, the electronic device is caused to perform the method shown in the above embodiments.

According to one aspect of this disclosure, a computer program product or computer program is provided and includes computer instructions stored in a computer-readable storage medium. The processor of a computer device reads the computer instructions from the computer-readable storage medium, and executes the computer instructions, thereby causing the computer device to implement the methods provided in the above various optional implementations.

Computer program code for performing the operations of this disclosure may be written in one or more programming languages, including object-oriented programming languages such as Java, Smalltalk, C++; and conventional procedural programming languages, such as “C” or a similar programming language. The program code may execute entirely on the user's computer, or partly on the user's computer, or as a stand-alone software package, or partly on the user's computer and partly on a remote computer, or entirely on the remote computer or server. In situations involving remote computers, the remote computer(s) can be connected to the user's computer through any kind of network, including a local area network (LAN) or a wide area network (WAN), or can be connected to an external computer (such as through Internet connection by an Internet service provider).

The flowcharts and block diagrams in the figures illustrate the architecture, functionality, and operations of possible implementations of systems, methods, and computer program products according to various embodiments of this disclosure. In this regard, each block in the flowchart or block diagram may represent a module, segment, or portion of code that contains one or more logic functions that implement the specified executable instructions. It should also be noted that, in some alternative implementations, the functions noted in the block may occur out of the order noted in the figures. For example, two blocks shown one after another may actually execute substantially in parallel, or they may sometimes execute in the reverse order, depending on the functionality involved. It will also be noted that each block of the block diagram and/or flowchart illustration, and combinations of blocks in the block diagram and/or flowchart illustration, can be implemented by special purpose hardware-based systems that perform the specified functions or operations, or can be implemented using a combination of specialized hardware and computer instructions.

The modules involved in the embodiments of this disclosure can be implemented in software or hardware. The name of a module does not constitute a limitation on the module itself under certain circumstances. For example, module A can also be described as “module A configured to perform operation B”.

The above description is only a description of some preferred embodiments of this disclosure and the technical principles applied. Those skilled in the art should understand that the disclosure scope involved in this disclosure is not limited to technical solutions composed of specific combinations of the above technical features, but should also cover other technical solutions formed by any combination of the above technical features or equivalent features thereof without departing from the above disclosed concept, for example, a technical solution formed by replacing the above features with technical features having similar functions disclosed in (but not limited to) this disclosure.

1. A communication method, applied to a non-access-point multi-link device (Non-AP MLD), comprising:
determining a target radio frame, wherein the target radio frame comprises a first identification bit, and the first identification bit indicates that a target traffic identifier (TID) is mapped to a new link corresponding to a new affiliated AP of an access point multi-link device (AP MLD); and
sending the target radio frame.

2. The communication method according to claim 1, wherein the first identification bit is carried in a TID-to-Link mapping information element of the target radio frame.

3. The communication method according to claim 2, wherein a control field of the TID-to-Link mapping information element comprises a second identification bit, and the second identification bit indicates that the TID-to-Link mapping information element is TID-to-Link mapping of the new link.

4. The communication method according to claim 2, wherein the TID-to-Link mapping information element comprises a third identification bit, the third identification bit indicates a mapping type of the TID-to-Link mapping; and
the mapping type comprises: uplink mapping, downlink mapping, or uplink and downlink mapping.

5. The communication method according to claim 4, wherein, the mapping type comprises the uplink mapping or the downlink mapping, the target radio frame comprises two TID-to-Link mapping information elements;
a control field of the TID-to-Link mapping information element comprises a fourth identification bit, and the fourth identification bit indicates that the TID-to-Link mapping information element is TID-to-Link mapping of the new link.

6. The communication method according to claim 5, wherein the fourth identification bit is carried in a reserved subfield of the control field.

7. The communication method according to claim 2, wherein before sending the target radio frame, the method comprises:
stopping data transmission on a first link with the AP MLD or releasing TID-to-Link mapping on the first link, wherein the first link is a non-new link having a TID.

8. A communication method, applied to an access point multi-link device (AP MLD), characterized in comprising:
receiving a target radio frame, wherein the target radio frame comprises a first identification bit, and the first identification bit indicates that a target traffic identifier (TID) is mapped to a new link corresponding to a new affiliated AP of the AP MLD; and
mapping, according to the first identification bit, the target TID to the new link corresponding to the new affiliated AP.

9-10. (canceled)

11. An electronic device, comprising a memory, a processor and a computer program stored in the memory and executable on the processor, wherein the processor is configured to, upon executing the program, implement the method according to claim 8.

12. A non-transitory computer-readable storage medium storing a computer program thereon, wherein the computer program is used for, upon being executed by a processor, implementing the method according to claim 1.

13. A non-transitory computer-readable storage medium, storing a computer program thereon, wherein the computer program is used for, upon being executed by a processor, implementing the method according to claim 8.

14. A non-access-point multi-link device (Non-AP MLD), comprising a memory, a processor and a computer program stored in the memory and executable on the processor, wherein the processor, upon executing the program, is configured to:
determine a target radio frame, wherein the target radio frame comprises a first identification bit, and the first identification bit indicates that a target traffic identifier (TID) is mapped to a new link corresponding to a new affiliated AP of an access point multi-link device (AP MLD); and
send the target radio frame.

15. The Non-AP MLD according to claim 14, wherein the first identification bit is carried in a TID-to-Link mapping information element of the target radio frame.

16. The Non-AP MLD according to claim 15, wherein a control field of the TID-to-Link mapping information element comprises a second identification bit, and the second identification bit indicates that the TID-to-Link mapping information element is TID-to-Link mapping of the new link.

17. The Non-AP MLD according to claim 15, wherein the TID-to-Link mapping information element comprises a third identification bit, the third identification bit indicates a mapping type of the TID-to-Link mapping; and
the mapping type comprises: uplink mapping, downlink mapping, or uplink and downlink mapping.

18. The Non-AP MLD according to claim 17, wherein, the mapping type comprises the uplink mapping or the downlink mapping, the target radio frame comprises two TID-to-Link mapping information elements;
a control field of the TID-to-Link mapping information element comprises a fourth identification bit, and the fourth identification bit indicates that the TID-to-Link mapping information element is TID-to-Link mapping of the new link.

19. The Non-AP MLD according to claim 18, wherein the fourth identification bit is carried in a reserved subfield of the control field.

20. The Non-AP MLD according to claim 15, wherein the processor is further configured to:
stop data transmission on a first link with the AP MLD or release TID-to-Link mapping on the first link, wherein the first link is a non-new link having a TID.
